(19) United States
(12) Patent Application Publication
(10) Pub. No.: US 2015/0018443 A1
(43) Pub. Date: Jan. 15, 2015

(54) Cushioning Foams Containing Reflective Particulates With Visually Distinguishable Reflective Surfaces to Create a Unique Appearance

(71) Applicant: Peterson Chemical Technology, Inc., Fort Smith, AR (US)

(72) Inventors: Bruce W. Peterson, Fort Smith, AR (US); Mark L. Crawford, Rudy, AR (US); Matthew D. McKnight, Fort Smith, AR (US)

(73) Assignee: Peterson Chemical Technology, Inc., Fort Smith, AR (US)

(21) Appl. No.: 14/161,870

(22) Filed: Jan. 23, 2014

Related U.S. Application Data
(63) Continuation-in-part of application No. 14/054,071, filed on Oct. 15, 2013.
Application No. 14/054,071 is a continuation-in-part of application No. 13/932,492, filed on Jul. 1, 2013.
Application No. 14/054,071 is a continuation-in-part of application No. 12/713,586, filed on Feb. 26, 2010.
Application No. 12/713,586 is a continuation-in-part of application No. 13/932,535, filed on Jul. 1, 2013.
Application No. 13/932,535 is a continuation-in-part of application No. 12/713,586, filed on Feb. 26, 2010.
Application No. 12/713,586 is a continuation-in-part of application No. 14/135,143, filed on Dec. 19, 2013.
Application No. 14/135,143 is a continuation-in-part of application No. 13/932,492, filed on Jul. 1, 2013.
Application No. 14/135,143 is a continuation-in-part of application No. 12/713,586, filed on Feb. 26, 2010.
Application No. 12/713,586 is a continuation-in-part of application No. 14/135,221, filed on Dec. 19, 2013.
(60) Provisional application No. 61/667,810, filed on Jul. 3, 2012.
(60) Provisional application No. 61/667,824, filed on Jul. 3, 2012.
(60) Provisional application No. 61/746,346, filed on Dec. 27, 2012.
(60) Provisional application No. 61/667,810, filed on Jul. 3, 2012.
(60) Provisional application No. 61/746,369, filed on Dec. 27, 2012.

(51) Int. Cl. C08J 9/00

(52) U.S. Cl. CPC C08J 9/0066; C08J 9/0061; C08J 9/0004; C08J 2205/06; C08J 2375/04
USPC 521/170; 521/50; 521/187

(57) ABSTRACT

Methods and combinations for making and using reflective particulate foam comprising flexible cellular foam and a plurality of reflective particulates randomly and/or uniformly dispersed during the production of the reflective particulate foam. Reflective particulates have reflective surfaces which are visually distinguishable as individual reflective particulates without the use of magnification. Reflective particulate foam provides a novel and uniquely distinguishable appearance for use on, under, or within mattresses, pillows, bedding products, medical cushioning foams, outdoor bedding pads, pet beds, outdoor pillows, cushioned display cases, cushioned package containers, and other cushioning products.

### CROSS-REFERENCES TO RELATED APPLICATIONS

This application is a continuation-in-part application of
U.S. patent application Ser. No. 14/054,071 filed Oct. 15, 2013 which is a continuation-in-part application of U.S. patent application Ser. No. 13/932,492 filed Jul. 1, 2013 which claims the benefit of U.S. Provisional Patent Application No. 61/667,810 filed Jul. 3, 2012 and is a continuation-in-part of U.S. patent application Ser. No. 12/713,586 filed Feb. 26, 2010 and a continuation-in-part application of U.S. patent application Ser. No. 13/932,535 filed Jul. 1, 2013, which claims the benefit of U.S. Provisional Patent Application No. 61/667,824 filed Jul. 3, 2012 and is a continuation-in-part application of U.S. patent application Ser. No. 12/713,586 filed Feb. 26, 2010;
U.S. patent application Ser. No. 14/135,143 filed Dec. 19, 2013 which claims the benefit of U.S. Provisional Patent Application No. 61/746,346 filed Dec. 27, 2012 and is also a continuation-in-part application of U.S. patent application Ser. No. 13/932,492 filed Jul. 1, 2013 which claims the benefit of U.S. Provisional Patent Application No. 61/667,810 filed Jul. 3, 2012 and is a continuation-in-part of U.S. patent application Ser. No. 12/713,586 filed Feb. 26, 2010; and
U.S. patent application Ser. No. 14/135,221 filed Dec. 19, 2013 which claims the benefit of U.S. Provisional Patent Application No. 61/746,369 filed Dec. 27, 2012; each incorporated herein in its entirety by reference.

### TECHNICAL FIELD

The invention relates to methods for making and using flexible cellular foam comprising reflective particulates dispersed within the flexible cellular foam, where said reflective particulates have at least one reflective surface that is of sufficient size to be visually distinguishable from the flexible cellular foam without the use of magnification, where in one non-limiting embodiment the reflective surface size is defined as from about 0.10 microns to about 3000 microns average size of the reflective surface. The invention more specifically relates to various types of flexible cellular foams containing reflective particulates including, but not necessarily limited to, mattresses, pillows, mattress topper pads, quilted toppers, medical mattresses, packaging foams, pet beds, outdoor bedding pads, outdoor pillows, cushioned display cases, cushioned package containers, and other cushioning products.

### TECHNICAL BACKGROUND

In the field of flexible polyurethane foams, there has been some use of reflective films to help trap heat to help provide extra warmth for inner spring mattresses. The use of small particulates that are reflective to produce a unique and characteristic looking product has been largely unused in the foam industry.

US 2006/0288499 A1 disclosed the use of a décor product that is a spray material that comprises an adhesive material and decorative additives such as glitter. This décor material is a post-treatment spray designed to give a decorative appearance to a wide array of substrate materials.

US 2004/0234771 A1 disclosed the use of materials such as glitter and other reflective additives to create a reflective or textured surface on a polymeric film. This polymeric material is a thermoformed polymer for molding three-dimensionally shaped films and objects.

US 2008/0289633 disclosed the use of additives to provide a visual indication of where the compression of gel or foam is highest.

U.S. Pat. No. 4,326,310 disclosed the concept and method of manufacturing a foam mattress topper with an aluminum silicon film on a cloth backing to reflect thermal heat back to the sleeper and help insulate the sleeper from losing heat to the environment.

U.S. Pat. No. 5,285,542 discloses a mattress topper that comprises fiber fill layers and metalized layers to assist in trapping heat. This was primarily intended for use with a waterbed to help insulate the sleeper from heat loss to the water.

### SUMMARY

There is provided, in one non-limiting form, methods of forming flexible cellular foam with reflective particulates (referred hereafter as “RP Foam”) comprised of a flexible cellular foam, which may be open or partially open-celled in nature, and a plurality of reflective particulates having at least one reflective surface per particle which is visually distinguishable as individual reflective particulates without the use of magnification, and said reflective particulates are dispersed in the flexible cellular foam prior to polymerization or crosslinking. It will be appreciated that the RP Foam may contain particulates that do not have at least one reflective surface and still be within the scope of the invention. Other performance modifying additives may optionally be incorporated into the foam. The RP Foam may contain reflective particulates in the range of about 0.05% independently to about 50% by weight based on the final net weight after gas loss of the RP foam.

Suitable flexible cellular foam include, but are not limited to, open-celled polyether polyurethane foam, partially open-celled polyether polyurethane foam, reticulated polyurethane foam, high-resiliency polyether polyurethane foam, open-celled viscoelastic polyether polyurethane foam, partially open-celled viscoelastic polyether polyurethane foam, open-celled polyester polyurethane foam, partially open-celled polyester polyurethane foam, open-celled polyester foam, partially open-celled polyester foam, latex foam, melamine foam, and combinations thereof.

The RP Foam may be cut or molded into many structures such as, but not limited to, planar layers, convoluted layers, surface-modified layers, 3D surface texturing, molded pillows, smooth molded surfaces, or molded surfaces with regular or irregular patterns, or modified in any way as to generate a desired physical structure such as, but not limited to, hole punching, channeling, reticulation or any other method known to the art of foaming for modifying the structure of foam. The RP Foam may be adhered in the cushion or mattress composite with adhesive or melting of a thermoplastic on the foam surface and allowing the thermoplastic to re-solidify and lock the foam in place on the substrate foam.

There is also provided, in a non-limiting embodiment, combinations of suitable layering substrates including, but not limiting to, flexible polyurethane foam, latex foam, flexible melamine foam, and other substrates (such as fibers in woven or non-woven form) with at least one RP Foam. Articles that may be manufactured from these combinations include, but are not necessarily limited to, mattresses, mattress toppers, pillows, bedding products, pet beds, quilted mattress toppers, pillow or mattress inserts, contoured support foam, outdoor bedding pads, outdoor bedding pillows, cushioned display cases, cushioned package containers, or other cushioning products.

### BRIEF DESCRIPTION OF THE DRAWINGS

FIG. 1 is an example blending system of polyol and reflective particulates;

FIG. 2 is a first example of construction using a cushion and/or mattress application implementing the RP Foams described herein;

FIG. 3 is a second example of construction using a cushion and/or mattress application implementing the RP Foams described herein;

FIG. 4 is a third example of construction using a cushion and/or mattress application implementing the RP Foams described herein;

FIG. 5 is a fourth example of construction using a cushion and/or mattress application implementing the RP Foams described herein;

FIG. 6 is a fifth example of construction using a cushion and/or mattress application implementing the RP Foams described herein;

FIG. 7 is a sixth example of construction using a cushion and/or mattress application implementing the RP Foams described herein;

FIG. 8 is a seventh example of construction using a cushion and/or mattress application implementing the RP Foams described herein;

FIG. 9 is an eighth example of construction using a cushion and/or mattress application implementing the RP Foams described herein;

FIG. 10 is a ninth example of construction using a cushion and/or mattress application implementing the RP Foams described herein;

FIG. 11 shows an example breakdown of lateral mattress zones in a cushion and/or mattress application;

FIG. 12 shows an example breakdown of longitudinal mattress zones in a cushion and/or mattress application;

FIG. 13 is an example of a molded pillow product where the entire structure is molded from RP Foam;

FIG. 14 is an example of a molded pillow product where the RP Foam is a region or layer within the pillow;

FIG. 15 is an example of a ring display box with RP Foam;

FIG. 16 is a photograph of a medium-to-high level of reflective flake particulates in open-celled flexible polyurethane foam; and

FIG. 17 is a photograph of a low level of reflective flake particulates in open-celled flexible polyurethane foam.

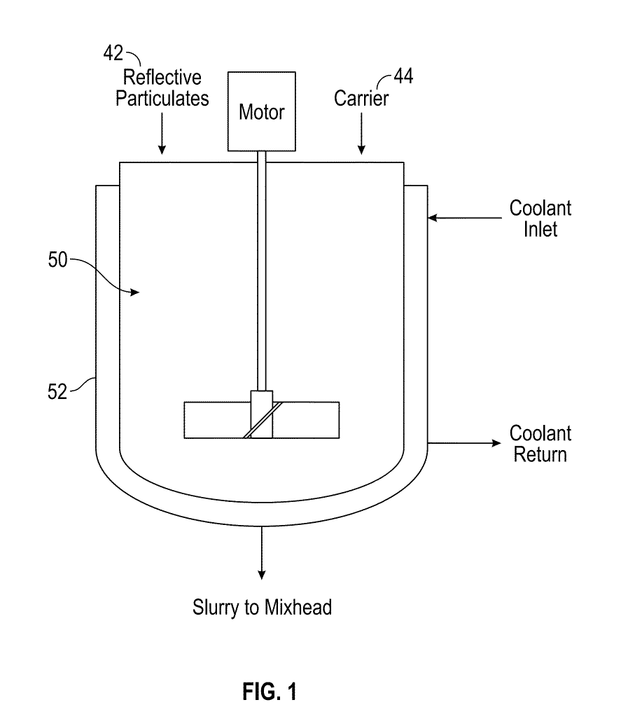

It will be appreciated that FIGS. 1-15 are schematic and that the various elements are not necessarily to scale or proportion, and that many details have been removed or simplified for clarity, and thus the methods and compositions are not necessarily limited to the embodiments depicted in the Figures.

Before the methods and compositions are explained in detail, it is to be understood that these methods and compositions are not limited in their application to the details of construction and the arrangements of the components set forth in the following description or illustrated in drawings. Also, it is understood that the phraseology and terminology used herein are for the purpose of description and should not be regarded as limiting.

### DETAILED DESCRIPTION

It is useful for designing product appearance and creating product recognition to develop RP Foams that provide a novel and uniquely distinguishable appearance for use on, under, or within mattresses, pillows, bedding products, medical cushioning foams, outdoor bedding pads, pet beds, outdoor pillows, cushioned display cases, cushioned package containers, and other cushioning products.

RP Foams are comprised of flexible cellular foam, which may be open or partially open-celled in nature, and a plurality of reflective particulates having at least one reflective surface per particle which is visually distinguishable as individual reflective particulates without the use of magnification, and said reflective particulates are dispersed in the flexible cellular foam prior to polymerization or crosslinking. The reflective particulates may be randomly or uniformly dispersed in the flexible cellular foam, or some combination of these dispersions. Alternatively, the reflective particulates may be intentionally concentrated in one region of the foam, or may increase gradually increase in concentration in a gradient from one portion of the foam to another. A reflective surface on a reflective particulate is defined as a surface such that visible light is reflected on an internal or external surface, where the internal or external surface is optionally coated with a material exhibiting gloss units of greater than about 10 or a Reflectivity of greater than about 0.20.

Flexible cellular foams may include, but are not limited to, open-celled polyether polyurethane foam, partially open-celled polyether polyurethane foam, reticulated polyurethane foam, high-resiliency polyether polyurethane foam, open-celled viscoelastic polyether polyurethane foam, partially open-celled viscoelastic polyether polyurethane foam, open-celled polyester polyurethane foam, partially open-celled polyester polyurethane foam, open-celled polyester foam, partially open-celled polyester foam, latex foam, melamine foam, and combinations thereof.

The RP Foam contains reflective material in the range of about 0.05% independently to about 50% by weight based on the final net weight after gas loss of the RP foam. Alternatively, the RP Foam contains reflective material in the range of about 0.1% independently to about 40% by weight based on the final net weight after gas loss of the RP foam, and in another non-limiting embodiment in the range of about 0.2% independently to about 25% by weight based on the final net weight after gas loss of the RP foam, and, in a different non-restrictive version, in the range of about 0.4% independently to about 20% by weight based on the final net weight after gas loss of the RP foam. The term “independently” as used in association with various ranges herein means that any lower threshold may be combined with any upper ratio to form a suitable alternative range.

For reflective particulate materials to be useful in creating the unique appearance desired, it is necessary for the materials to reflect an appropriate amount of light back to the viewer. The property most indicative of the shine observable to the viewer is “Reflectivity” which is defined as the measure of the total amount of radiant flux reflected from a sample as a fraction of the total amount of radiant flux incident on the sample from the light source for a given wavelength. The Reflectivity may be affected by the angle of incidence of the light on the surface of the particle as well as being affected by the wavelength of the light incident on the particle. For this invention, the Reflectivity of a particle will be measured by placing a particle in a sample mounting, illuminating the particle at near-normal incidence (5 degrees from the normal vector of the surface), such that the specular reflection beam will be included in the measurement, with a white light source, and measuring the Reflectivity over the range of visible light (wavelength 350 nm to 900 nm). An integrating sphere or spectrophotometer with spherical geometry may be used to measure the Reflectivity. The particle will be considered to have reflective properties if any sub-range of the visible spectrum has a Reflectivity greater than about 0.20. A “sub-range” is defined herein as any smaller wavelength range within the visible light wavelength range of about 350 nm to about 900 nm. In one non-limiting embodiment, a suitable sub-range is from about 390 independently to about 800 nm; alternatively from about 400 to about 700 nm, where about 350 and about 900 nm are suitable alternative end points. At least one reflective surface on a particulate is sufficient to make the particulate a reflective particulate, and the reflective surface is defined as a surface on which visible light is reflected by an internal or external surface with reflection properties exhibiting a Reflectivity of more than about 0.20, where the internal or external surface is optionally coated with a material with higher Reflectivity than the base particulate.

Reflective particulates may be in the form of, but not limited to, flake, powder, shaped, and combinations thereof. Reflective particulates may include, but are not limited to, glitter particulates comprised of a polymeric material such as polyvinyl chloride, polyester, polyurethane, epoxy resin, polyethylene, polycarbonate, polyethylene terephthalate, and a reflective surface comprised of internal or external polymeric material plane with optional coating of aluminum, aluminum oxide, titanium dioxide, iron oxide, bismuth oxychloride, silver, gold, platinum, and combinations thereof; mineral particulates such as diamond, corundum, silicon oxide, quartz, mica, calcite, topaz, beryl, fluorite, sphalerite, cinnabar, cuprite, ulexite, gypsum, amber, pyrite, magnetite, galena, garnet, cerussite, zircon; metallic particulates such as aluminum, aluminum oxide, iron, iron oxide, copper, copper oxide, platinum, titanium, titanium oxide, gold, silver, bismuth oxychloride, bronze, brass, tin, lead, or any combinations thereof; glass or composites of glass and any reflective material; or any combination of materials to generate a reflective surface. The reflective particulates may themselves be comprised of any of the above materials, per se.

The reflective particulates may include, but are not necessarily limited to, planar structures such as circular, hexagonal, rectangular or other planar polygonal structures; structures with curvature such as a single concave or convex surface, two concave or convex surfaces, or some combination of convex, concave or otherwise curved surface developed on the reflective flake, 3-dimensional structures such as pyramids, prisms, cubes, ellipsoids or spheres, a “corner reflector” or other retroreflector structure; or other various particulate forms, such as random particle shapes or irregular particle shapes or combinations thereof. Suitable shapes including, but not necessarily limited to sequin shapes.

The reflective particle contains at least one reflective surface which can be visually distinguishable as reflective without the use of magnification, and the overall particle size is small enough to avoid compromising the structural integrity and feel of the RP Foam. A suitable size of reflective surfaces may be between about 0.1 microns independently to about 3000 microns, alternatively between about 1 micron independently to about 2000 microns, and in another non-limiting embodiment between about 10 microns independently to about 1000 microns. The overall particle size of the reflective particulate may be less than about 3000 microns, alternatively less than about 2000 microns, and in another non-limiting embodiment less than about 1000 microns. In one non-limiting embodiment, any one of these size ranges may be a sufficient size or an effective size to permit the reflective particulates to be visually distinguishable from the flexible cellular foam without the use of magnification.

Reflective particulates may be obtained by many different manufacturing techniques known in the skill of the art that is reflective particulate manufacturing. A non-limiting list of reflective flake manufacturing processes may include lamination, thin-film deposition, electroless plating, vapor deposition, molding, ball milling, rotary drum flaking, crystalline growth, extruding, exuding, drawing, decambering, ironing, incremental sheet forming, size reduction of larger reflective materials such as shaving, grinding, jaw crushing, gyratory crushing, roll crushing, impact breaking, pan crushing, tumble milling, non-rotary ball milling, particle-size classifiers used with grinding mills, hammer milling, ring-roller milling, disk attrition milling, jet milling, cutting milling, saw milling, disk sanding, filing, and combinations thereof.

In a non-limiting embodiment, reflective particulates may be sized by air classification, static screens, rotary sifters, centrifugal screens, vibratory screens, gyratory screens, cyclone separators, and combinations thereof. Alternatively, the particulates may be sized based on wet classification techniques such a cone type classifier, liquid cyclone, hydro-separator, solid-bowl centrifuge, countercurrent classifier, jet sizer, super-sorter, and combinations thereof.

In a non-limiting embodiment, the reflective particulates may be manufactured in the presence of mineral oil, aliphatic oil, synthetic oil, petrochemical oil, vegetable oil, fruit oil, fat oil, silicon lubricant, hydrogenated polyolefins, fluorocarbons, esters, polyalkylene glycols, phosphate esters, silicate esters, alkylated naphthalenes, ionic fluids, isoparaffins, paraffins or other non-aqueous lubricating material, which may be present in concentrations of up to 99% by weight in the reflective particle blend. These manufacturing aids may be accounted for in RP Foam formulations.

In another non-limiting embodiment, the reflective particulates are not provided inside a flexible cellular foam in a manner that can provide a visual indication of where compression is highest in use.

The RP Foam may also contain useful amounts of conventionally employed additives (“property-enhancing additives”) such as plasticized triblock copolymer gels, stabilizers, antioxidants, antistatic agents, antimicrobial agents, ultraviolet stabilizers, phase change materials, surface tension modifiers such as silicone surfactants, emulsifying agents, and/or other surfactants, solid flame retardants, liquid flame retardants, grafting polyols, compatible hydroxyl-containing chemicals which are completely saturated or unsaturated in one or more sites, solid or liquid fillers, anti-blocking agents, colorants such as inorganic pigments, carbon black, organic colorants or dyes, reactive organic colorants or dyes, heat-responsive colorants, heat-responsive pigments, heat-responsive dyes, pH-responsive colorants, pH-responsive pigments, pH-responsive dyes, fragrances, viscosity-modifiers such as fumed silica and clays, thermally conductive-enhancing additives such as aluminum and graphite, and combinations thereof, and other polymers in minor amounts and the like to an extent not affecting or substantially decreasing the desired properties of the RP Foam.

In a non-limiting embodiment, the reflective particulates may be localized onto gel additives comprised of plasticized A-B-A tri-block copolymers which may be in particulate form with average particle size of less than 10 mm. This may be accomplished by any of a variety of methods which include, but are not limited to, blending of the reflective particulate with gel particles to cause the reflective material to migrate into crevices and cavities and remain partially trapped or to simply be attached to the surface of the gel particles by the adhesion between excess plasticizer and the reflective material, or by the addition of reflective material to un-plasticized or partially plasticized A-B-A tri-block copolymer and then adding additional plasticizing material causing the copolymer to soften and incorporate the reflective material into the gel particles, or by adding the reflective material to gel particles and mixing while heating the gel slightly to allow the gel to partially melt and then cool and reform with the reflective material captured and incorporated into or on the surface of the gel particles, or by any other methods by which the reflective material may be caused to attach, adhere, or otherwise become localized to the gel particles. These may be understood to be particle gel with reflective particulates which are incorporated into the RP Foam.

Suitable A-B-A tri-block copolymers include, but are not necessarily limited to, (SIS) styrene-isoprene-styrene block copolymers, (SEBS) styrene-ethylene-butylene-styrene block copolymers, (SEPS) styrene-ethylene-propylene-styrene block copolymers, (SEEPS) styrene-ethylene-ethylene-propylene-styrene block copolymers, (SBS) styrene-butadiene-styrene block copolymers and the like. The A-B-A tri-block copolymers employed may have the more general configuration of A-B-A. The A component represents a crystalline polymer end block segment of polystyrene; and the B component represents an elastomeric polymer center block segment. These “A” and “B” designations are only intended to reflect conventional block segment designations.

Plasticizers added to tri-block copolymers, suitable for making acceptable gelatinous tri-block copolymer elastomers are well known in the art, include, but are not necessarily limited to, rubber processing oils such as paraffinic petroleum oils, naphthenic petroleum oils, highly-refined aromatic-free paraffinic oils and naphthenic food and technical grade white petroleum mineral oils; synthetic oils; natural oils; and polyols made from natural oils and natural polyols. Synthetic oils are high viscosity oligomers such as non-olefins, isoparaffins, paraffins, aryl and/or alkyl phosphate esters, aryl and/or alkyl phosphite esters, polyols, and glycols. Many such oils are known and commercially available. Examples of various commercially available oils include, but are not necessarily limited to, PAROL® and TUFFLO® oils. Natural oils such as, but not limited to, canola oil, safflower oil, sunflower oil, soybean oil, and/or castor oils may be used. Natural oil-based polyols are biologically-based polyols such as, but not limited to, soybean-based and/or castor bean polyols. The plasticizer constitutes about 1 independently to about 1,400 pph (parts per hundred parts of A-B-A tri-block copolymer resin), alternatively about 100 independently to about 1200 pph (parts per hundred parts of A-B-A tri-block copolymer resin) in a gel, and alternatively about 300 independently to about 1000 pph (parts per hundred parts of A-B-A tri-block copolymer resin) in gelatinous A-B-A tri-block copolymer elastomer.

RP Foams may be prepared by a method or methods including batch production of open boxes or molds, or continuous production using a free-rise slab foam line such as the MAXFOAM process or direct lay-down (conventional) process. In one non-limiting embodiment, the reflective material may be incorporated or blended into the polyol blend in a batch or continuous process in a blending system such as a continuous stirred tank, static mixing elements, air mixers, or any other equipment known in the skill of the art that is used for mixing solids and additives with liquids.

One non-limiting embodiment of adding reflective particulates 42 to the compatible carrier 44 is by adding the reflective particulates 42 into a compatible carrier in a mix tank 50, as schematically illustrated in FIG. 1. A typical mix tank 50 may have a heating/cooling jacket 52 for controlling the temperature within the tank. The carrier is added to the mixing tank and then the reflective particulates 42 are mixed into the carrier while agitating. While mixing, the reflective particulates 42 may be added to the tank gradually or all at once. Alternatively, the reflective particulates 42 may be added to the mixing tank first and then the compatible carrier added to the tank while mixing. Another non-limiting method of adding reflective particulates to the compatible carrier is by transferring the reflective particulates into a mix chamber using an auger, where the reflective particulates and compatible carrier are mixed prior to adding other chemicals required to make RP Foam. Alternatively, mixing may be performed directly into the main mix head or may be mixed in a separate mix head and the reflective particulates and compatible carrier mixture fed into the main mix head with the other formulation components. Another non-restrictive method may be to use the auger to mix the reflective particulates and compatible carrier together while augering to the main mix head. It will be appreciated that the method described herein is not limited to these examples, since there are many possible combinations for combining reflective particulates with a compatible carrier before incorporating reflective particulates into a flexible cellular foam.

In a non-limiting embodiment, prior to polymerization, the raw materials for a RF Foam may be poured into a standard bun form on a conveyor, poured in a mold having planar or non-planar surfaces, textured with 2D and 3D modification, or poured in a mold with rods to make the foam perforated.

In another non-limiting embodiment, one or more RP Foams may be added within or on the surface or in any location within the interior cavity of a mold for making molded products such as, but not limited to, pillows, mattresses, mattress toppers, pet beds, seat cushions, display case cushions, packaging foams and individual substrate components added to the mold to react, bind, or encapsulate the RP Foam.

It will be appreciated that the methods described herein are not limited to these examples, since there are many possible combinations for making RP Foams that have a novel and uniquely distinguishable appearance for use on, under, or within mattresses, pillows, bedding products, medical cushioning foams, outdoor bedding pads, pet beds, outdoor pillows, cushioned display cases, cushioned package containers, and other cushioning products. Further details about making foams, including gel-foams, and the foam and gel-foam compositions so made may be seen in U.S. Patent Application Publication Nos. 2013/0295371 A1 and US 2013/0296449 A1, incorporated herein by reference in their entirety.

### Applications of the RP Foam

RP Foam may be manufactured and combined with substrate foams for use in a variety of applications, including but not necessarily limited to, mattresses, pillows, pillow toppers, mattress toppers, quilted toppers, body support foam, pet beds, outdoor bedding pads, outdoor pillows, cushioned display cases, cushioned package containers or other cushioning materials.

Layering substrates in combination with one or more RP Foams and optional property-enhancing materials may find utility in a very wide variety of applications. Suitable layering substrates include, but are not limited to, flexible polyurethane foam, flexible polyester polyurethane foam, latex foam, flexible melamine foam, and other substrates (such as fibers in woven or non-woven form), and combinations thereof. More specifically, in other non-limiting embodiments, the combination of RP Foam and substrate would be suitable for pillows or pillow components, including, but not necessarily limited to, pillow wraps or shells, pillow cores, pillow toppers; for cushioning and support products including, but not necessarily limited to, medical comfort pads, medical mattresses, residential/consumer mattresses, mattress topper pads, pet beds, outdoor bedding pads, outdoor pillows, and similar cushioning and support products, typically produced with conventional flexible polyurethane foam or fiber. All of these uses and applications are defined herein as “bedding products” or cushioning products.

Alternatively, the RF Foam may be used for cushioning material is a display case or box including, but not limited to, packaging or display containers for items such as, but not limited to, jewelry, artwork, knives, guns, cookware, utensils, watches, clocks, food products and the like.

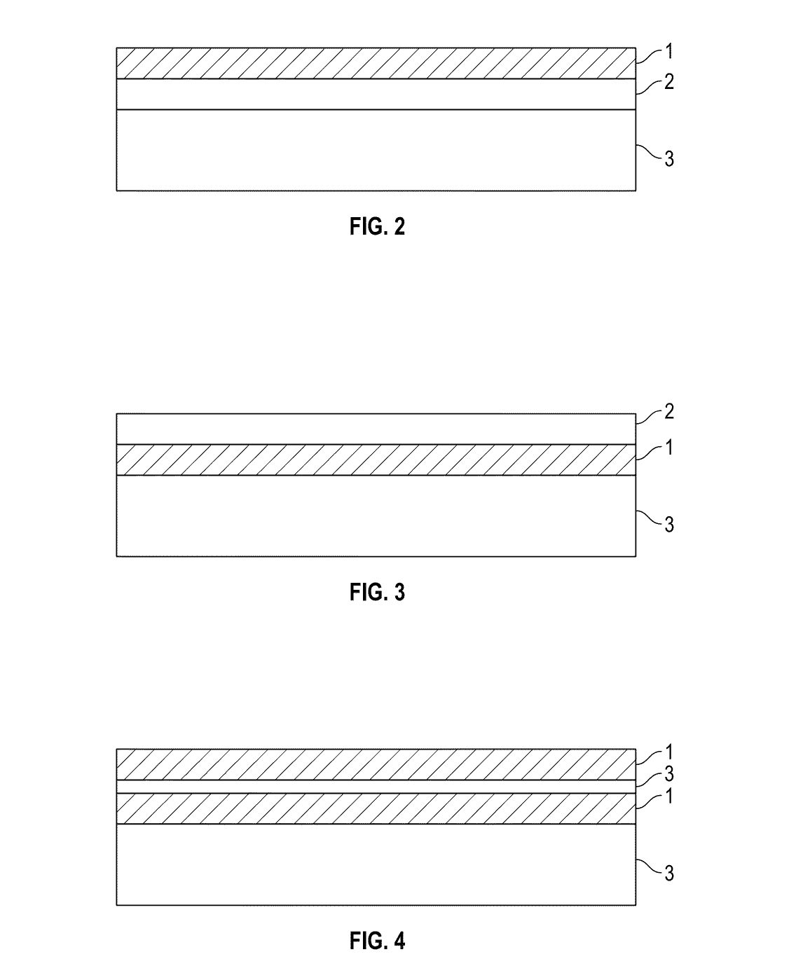

FIG. 2 is a first example of construction using a cushion and/or mattress application. The base of the section is a prime foam layer 3. On top of this is a 2 inch (5 cm) standard, open cell viscoelastic (visco) layer 2. The top layer 1 is a 2 inch (5 cm) layer of RP Foam. It will be appreciated that the dimensions given in the examples and descriptions of the various Figures are merely illustrative and are not intended to be limiting. Throughout the drawings, the same or similar reference numerals will be used for the same or similar structures.

FIG. 3 is a second example of construction using a cushion and/or mattress application. The base of the section is a prime foam layer 3. On top of this is a 2 inch (5 cm) layer of RP Foam 1 followed by a 2 inch (5 cm) layer 2 of standard, open cell viscoelastic foam.

FIG. 4 is a third example of construction using a cushion and/or mattress application. The base of the section is a prime foam layer 3. On top of this is a 2 inch (5 cm) layer of RP Foam 1 followed by a 0.75 inch (1.9 cm) layer 3 of prime foam. The top layer is a second 2 inch (5 cm) layer of RP Foam 1.

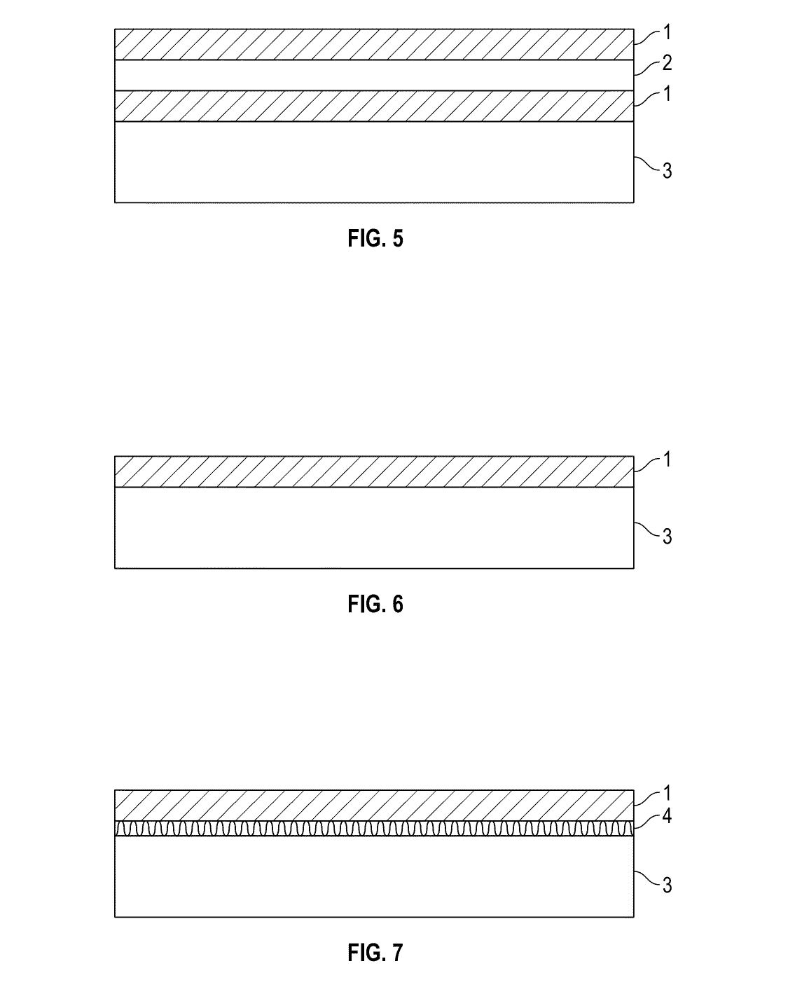

FIG. 5 is a fourth example of construction using a cushion and/or mattress application. The base of the section is a prime foam layer 3. On top of this is a 2 inch (5 cm) layer of RP Foam 1 followed by a 2 inch (5 cm) layer 2 of standard, open cell viscoelastic foam. The top layer is a second 2 inch (5 cm) layer of RP Foam 1.

FIG. 6 is a fifth example of construction using a cushion and/or mattress application. The base of the section is a prime foam layer 3. On top of this is a 3 inch layer of RP Foam 1.

FIG. 7 is a sixth example of construction using a cushion and/or mattress application. The base of the section is a prime foam layer 3. On top of this is a 3 inch (7.6 cm) layer of RP Foam 1. The interface 4 between the two layers is a non-planar convolution, which may be made by convoluting the surface of either or both interfacing layers.

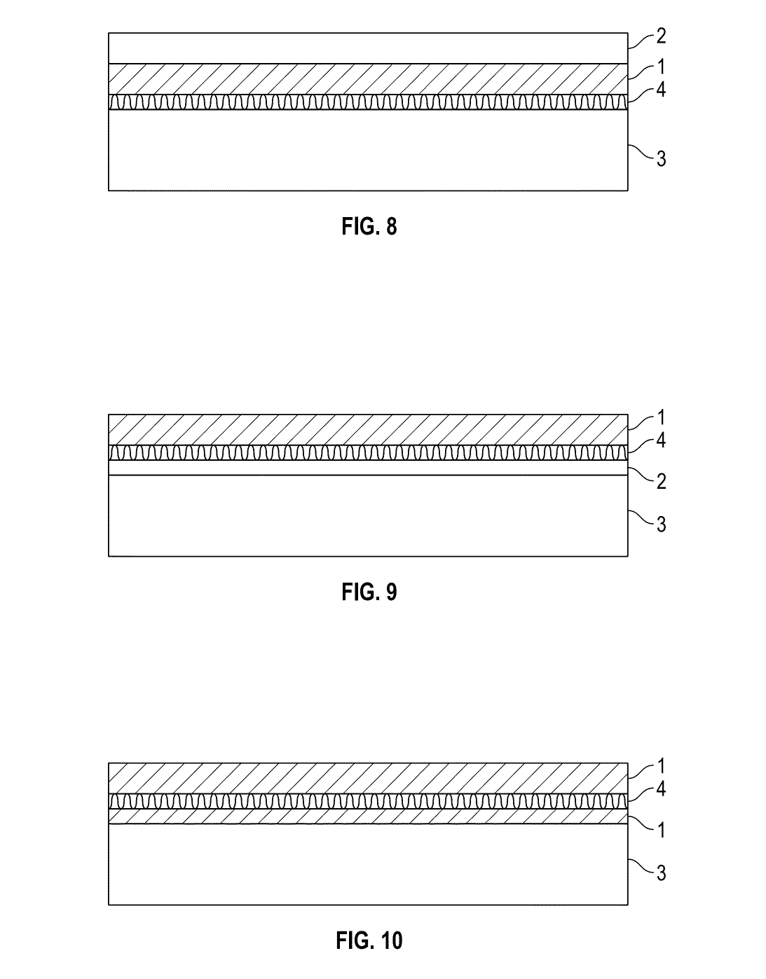

FIG. 8 is a seventh example of construction using a cushion and/or mattress application. The base of the section is a prime foam layer 3. On top of this is a 2 inch (5 cm) layer of RP Foam 1. The interface 4 between the two layers is a non-planar convolution, which may be made by convoluting the surface of either or both interfacing layers. The top of this example is a 2 inch (5 cm) layer 2 of standard, open-cell viscoelastic foam.

FIG. 9 is an eighth example of construction using a cushion and/or mattress application. The base of the section is a prime foam layer 3. Above this is a 2 inch (5 cm) layer 2 of standard, open-cell viscoelastic foam. On top of this is a 2 inch layer (5 cm) of RP Foam 1. The interface 4 between the two layers is a non-planar convolution, which may be made by convoluting the surface of either or both interfacing layers.

FIG. 10 is a ninth example of construction using a cushion and/or mattress application. The base of the section is a prime foam layer 3. Above this is a 2 inch (5 cm) layer of RP Foam 1. On top of this is another 2 inch (5 cm) layer of RP Foam 1. The interface 4 between the two layers is a non-planar convolution, which may be made by convoluting the surface of either or both interfacing layers.

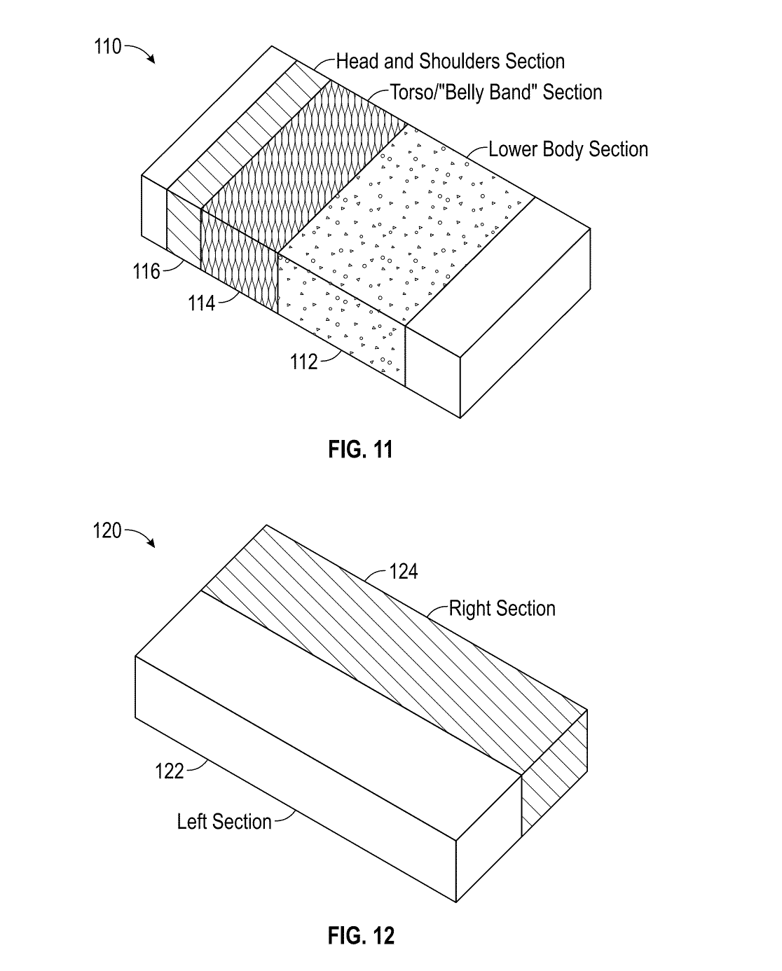

FIG. 11 is an example breakdown of lateral mattress zones or sections in a mattress 110. These zones include: lower body zone or section 112, torso/“belly band” zone or section 114, and head & shoulders zone or section 116. These zones or sections may or may not include RP Foams, example constructions, other mattress layer constructions, or any variation thereof. Furthermore, the zones shown are not limiting, but used as examples to show the possibility of utilizing differing layers in specific areas of cushions and/or a mattress.

FIG. 12 is an example breakdown of longitudinal mattress zones 122 and 124 in a mattress 120. These zones include left section 122 and right section 124. These zones or sections 122 and 124 may or may not include RP Foams, example constructions, other mattress layer constructions, or any variation thereof. Furthermore, the zones shown are not limiting, but used as an example to show the possibility of utilizing differing layers in specific areas of cushions and/or a mattress.

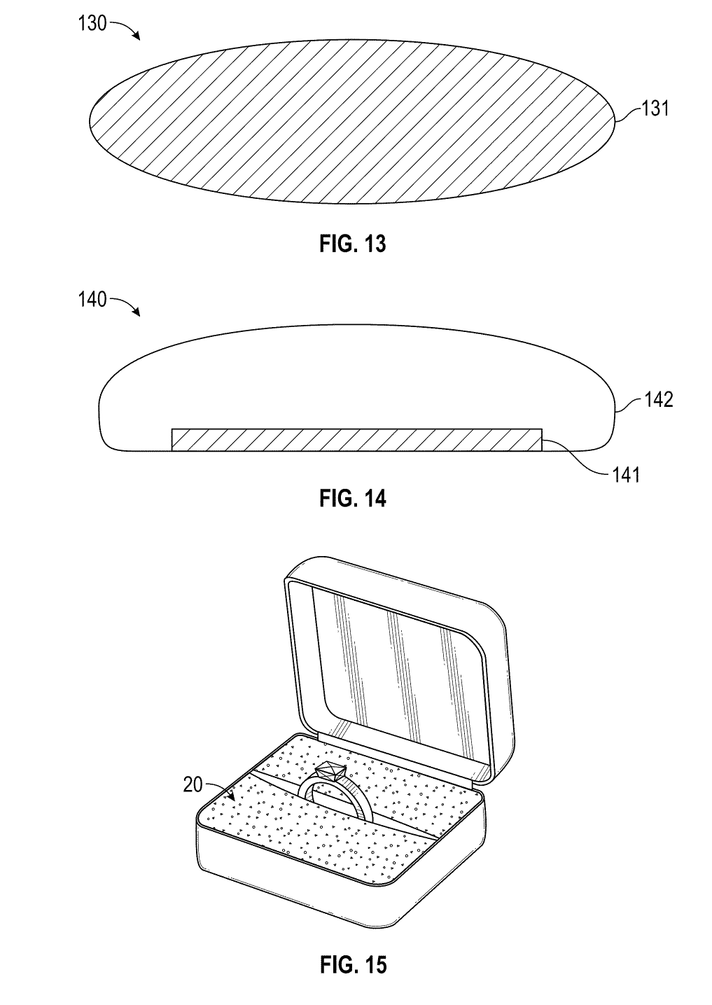

FIGS. 13 and 14 are depictions of molded pillow systems. FIG. 13 is a pillow 130 molded entirely out of RP Foam 131. FIG. 14 shows a pillow 140 using RP Foam 141 as a region within the overall pillow structure 142.

FIG. 15 is an example of a ring display box with RP Foam 20. This figure is meant to be illustrative of the use of RP Foam for packaging or display containers for items such as, but not limited to, jewelry, artwork, knives, guns, cookware, utensils, watches, clocks, food products and the like.

The invention will now be described more specifically with respect to particular formulations, methods and compositions herein to further illustrate the invention, but which examples are not intended to limit the methods and compositions herein in any way.

### Example 1

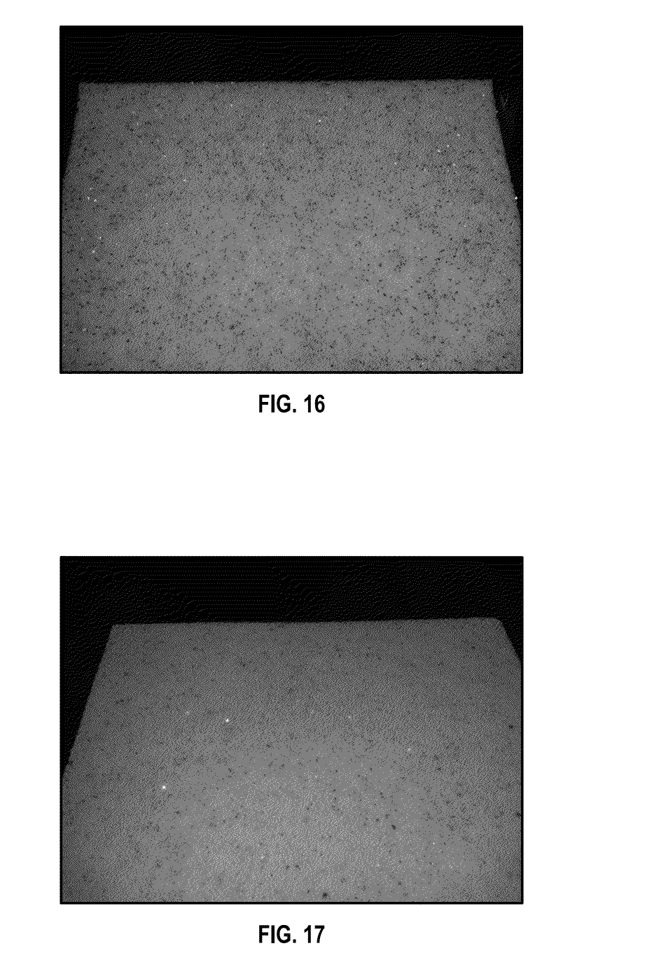

A two component system was obtained from Peterson Chemical Technology. The PCT-L-1213-15B system consisted of a “B” side containing polyols, surfactants, blowing and gelation catalysts and water, and the “A” side (PCT-M142A) consisted of an isocyanate compound. In a 32 oz (0.95 L) mix cup, 103.4 parts of the PCT-L-1213-15B “B” side was added to 30 parts of reflective flake additive material. The components were mixed for approximately 45 seconds before adding 43.30 parts of PCT-M142A “A” side component, mixed an additional 10 seconds and poured into a 9″×9″ (23 cm×23 cm) cake box and allowed to rise and cure in a room temperature environment. A flexible polyurethane foam was produced which is the control foam labeled Example 1 in Table 1. Foams were examined for the appearance and effect of the additives on the look of the surface. A photograph of this foam is pictured in FIG. 16. Numerous highlights from the reflective particulates may be seen.

### Example 2

A two component system was obtained from Peterson Chemical Technology. The PCT-M470B system consisted of a “B” side containing polyols, surfactants, blowing and gelation catalysts, and water, and the “A” side (PCT-M142A) consisted of an isocyanate compound. In a 32 oz (0.95 L) mix cup, the components were added as follows: 102.75 parts of the PCT-M470B “B” side and 10.75 parts of the BD-1075 additive. The BD additive is a blend of proprietary compounds which includes a reflective particulate additive. The components were mixed for approximately 45 seconds before adding 43.95 parts of PCT-M142A “A” side component, mixed an additional 10 seconds and poured into a 9″×9″ (23 cm×23 cm) cake box and allowed to rise and cure in a room temperature environment. A flexible polyurethane foam was produced which is labeled Example 2 in Table 1. Foams were examined for the appearance and effect of the additives on the look of the surface.

### Example 3

A two component system was obtained from Peterson Chemical Technology. The PCT-M347B system consisted of a “B” side containing polyols, surfactants, blowing and gelation catalysts and water, and the “A” side (PCT-M142A) consisted of an isocyanate compound. In a 32 oz (0.95 L) mix cup, the components were added as follows: 104.0 parts of the PCT-L6153B “B” side, 6.6 parts of a reflective material particulate and 30 parts GL-4153 blend, which were blended together prior to adding to PCT-L6153B liquid. The components were mixed for approximately 45 seconds before adding 44.03 parts of PCT-M142A “A” side component, mixed an additional 10 seconds and poured into a 9″×9″ (23 cm×23 cm) cake box and allowed to rise and cure in a room temperature environment. A flexible polyurethane foam was produced which is the labeled Example 3 in Table 1. Foams were examined for the appearance and effect of the additives on the look of the surface. This foam is pictured in FIG. 17. Numerous highlights from the reflective particulates may be seen, although the number of highlights is lower than that seen in FIG. 16.

### Discussion of Results

Table 1 shows the formula and test results for the foams produced by following the procedures of Examples 1, 2, and 3. FIG. 16 is a photograph of a medium-to-high level of reflective particulates in open-celled flexible polyurethane foam. FIG. 17 is a photograph of a low level of reflective flake particulates in open-celled flexible polyurethane foam.

TABLE 1
Comparison of Formula and Appearance of
RP Foam Examples 1, 2, and 3

| Sample | Units | Ex. 1 | Ex. 2 | Ex. 3 |
|---|---|---|---|---|
| PCT-L-1213- | pph | 103.4 | | |
| 15B | | | | |
| PCT-M470B | pph | | 102.75 | |
| PCT-M347B | pph | | | 104 |
| BD-1075 | pph | | 10.75 | |
| Reflective | pph | 30 | | |
| Particulate | | | | |
| Material | | | | |
| RP Gel | pph | | | 36.6 |
| Additive | | | | |
| PCT-M142A | pph | 43.3 | 43.95 | 44.03 |
| Cream | sec | 21 | 25 | 26 |
| Rise | sec | 140 | 155 | 204 |
| Settle | in | 0 | 0 | 0 |
| Appearance | | Slight green | Gray color | Slightly off- |
| | | color to the | foam with | white |
| | | background, | black | background, |
| | | even | particulate, | even |
| | | distribution of | and uniformly | distribution of |
| | | particulate, | distributed | all particulates |
| | | medium strong | medium weak | in RP blend, |
| | | sparkle | sparkles | medium |
| | | | | sparkle |

Many modifications may be made in the methods of and implementation of this invention without departing from the spirit and scope thereof that are defined only in the appended claims. For instance, various combinations of polyols, isocyanates, catalysts, reflective materials, and other additives, and processing pressures, temperatures, and conditions besides those explicitly mentioned herein are expected to be useful.

The words “comprising” and “comprises” as used throughout the claims are to be interpreted as “including but not limited to”. The present invention may suitably comprise, consist or consist essentially of the elements disclosed and may be practiced in the absence of an element not disclosed. In a non-limiting instance, there may be provided RP Foam that consists essentially of or consists of a flexible cellular foam and reflective material particulates dispersed in the flexible cellular foam.

There may also be provided a cellular foam comprising, consisting essentially of or consisting of cross-linked latex foam and reflective particulates randomly and/or uniformly dispersed in the cross-linked latex foam. The latex foam contains reflective material in the range of about 0.05% independently to about 50% by weight based on the final cross-linked weight of the latex foam. Alternatively, the latex foam contains reflective material in the range of about 0.1% independently to about 40% by weight based on the final cross-linked weight of the latex foam, and in another non-limiting embodiment in the range of about 0.2% independently to about 25% by weight based on the final cross-linked weight of the latex foam, and, in a different non-restrictive version, in the range of about 0.4% independently to about 20% by weight based on the final cross-linked weight of the latex foam. One process used for open-celled, flexible latex foam production involves adding the reflective particulates to the natural or synthetic latex liquid polymer, followed by introducing air into the latex, e.g. whipping or beating warm natural or synthetic latex in the presence of additives to promote open cell formation, stabilization and curing. Additives may include, but are not necessarily limited to, foam stabilizers, foam promoters, zinc oxide delayed action gelling agents, and combinations thereof. A final step in this process is to cure the foam with heat. Suitable latex foam production processes known by those skilled in the art for latex foam manufacturing include, but are not necessarily limited to, molded and free-rise latex methods produced with the Dunlop or Talalay latex processes. In the Talalay latex process, the latex foam may be cured by introducing carbon dioxide into the mold with latex. The carbon dioxide reacts with water forming carbonic acid, which lowers the pH and causes the latex to thicken and hold its cell structure and shape. The mold temperature is then raised to about 230° F. (110° C.) and held for a determined amount of time to crosslink or vulcanize the latex polymer. In the Dunlop process, the latex mixture is cured by addition of chemical additives such as sodium fluorosilicate, and later the latex is vulcanized or cross-linked by raising the temperature.

There may also be provided a cellular foam comprising, consisting essentially of or consisting of cross-linked melamine foam and reflective particulates dispersed in the cross-linked melamine foam. The melamine foam contains reflective material in the range of about 0.05% independently to about 50% by weight based on the final cross-linked weight of the melamine foam. Alternatively, the melamine foam contains reflective material in the range of about 0.1% independently to about 40% by weight based on the final cross-linked weight of the melamine foam, and in another non-limiting embodiment in the range of about 0.2% independently to about 25% by weight based on the final cross-linked weight of the melamine foam, and, in a different non-restrictive version, in the range of about 0.4% independently to about 20% by weight based on the final cross-linked weight of the melamine foam.

What is claimed is:

1. A reflective particulate foam (RP Foam) comprising:
a flexible cellular foam; and
reflective particulates having at least one reflective surface per particle that is of sufficient size to be visually distinguishable from the flexible cellular foam without the use of magnification, where said reflective particulates are dispersed in the flexible cellular foam.

2. The RP Foam of claim 1 wherein the flexible cellular foam is selected from the group consisting of open-celled polyether polyurethane foam, partially open-celled polyether polyurethane foam, reticulated polyurethane foam, high-resiliency polyether polyurethane foam, open-celled viscoelastic polyether polyurethane foam, partially open-celled viscoelastic polyether polyurethane foam, open-celled polyester polyurethane foam, partially open-celled polyester polyurethane foam, open-celled polyester foam, partially open-celled polyester foam, latex foam, melamine foam, and combinations thereof.

3. The RP Foam of claim 1 wherein the reflective particulates have a Reflectivity of at least 0.20 as measured by integrating the total reflected radiant flux for any sub-range of visible light in the wavelength range of about 350 nm to about 900 nm, when measured with near-normal incidence.

4. The RP Foam of claim 1 wherein the reflective particulates have an average particulates size ranging from about 0.1 microns to about 3000 microns.

5. The RP Foam of claim 1 wherein the reflective particulates are present in the range of from about 0.05% to about 50% by weight based on the final net weight after gas loss of the RP foam.

6. The RP Foam of claim 1 wherein the reflective particulates are a glitter material comprising a polymeric material selected from a group comprising polyvinyl chloride, polyester, polyurethane, epoxy resin, polyethylene, polycarbonate, polyethylene terephthalate, and combinations thereof.

7. The RP Foam of claim 1 wherein the reflective particulates are a mineral material selected from the group consisting of diamond, corundum, quartz, mica, topaz, fluorite, cinnabar, cuprite, pyrite, zircon, and combinations thereof.

8. The RP Foam of claim 1 wherein the reflective particulates are a metal material selected from the group consisting of aluminum, aluminum oxide, platinum, titanium, titanium oxide, gold, silver, tin, and combinations thereof.

9. The RP Foam of claim 1 wherein the reflective particulates have surface configurations selected from the group consisting of:
planar surface structures selected from the group consisting of circular, hexagonal, rectangular, other planar polygonal structures, and combinations thereof;
curved surface structures selected from the group consisting of single concave surface, single convex surface, two concave surfaces, two convex surfaces, and combinations thereof;
3-dimensional surface structures selected from the group consisting of pyramids, prisms, cubes, ellipsoids or spheres, a “corner reflector”, retroreflector structures, and combinations thereof;
random particle shapes;
irregular particle shapes; and
combinations thereof.

10. The RP Foam of claim 1 wherein the RP Foam is produced by a method comprising:
introducing reflective particulates into a mixture of flexible cellular foam-forming components comprising a polyol and an isocyanate; and
polymerizing the polyol and the isocyanate to form the RP foam.

11. An article of manufacture comprising the RP Foam of claim 1 where the article of manufacture is selected from the group consisting of medical cushioning foams, mattresses, pillows, bedding products, mattress pillow toppers, quilted mattress toppers, mattress topper pads, pet beds, indoor cushioning foams, outdoor cushioning foams, outdoor bedding pads, outdoor pillows, cushioned display cases, cushioned package containers, and combinations thereof.

12. The RP Foam of claim 1 wherein the RP Foam comprises a structure selected from the group consisting of a solid sheet, a perforated sheet, a non-planar sheet, a planar sheet, a textured sheet, and combinations thereof.

13. The RP Foam of claim 1 wherein the RP Foam is adhered to a layering substrate selected from a group comprising flexible polyurethane foam, flexible polyester polyurethane foam, latex foam, flexible melamine foam, woven fibers, non-woven fibers, and combinations thereof.

14. A cushion foam comprising at least one layer comprising the RP Foam of claim 1.

15. A mattress comprising at least one layer comprising the RP Foam of claim 1.

16. A mattress topper pad comprising at least one layer comprising the RP Foam of claim 1.

17. A pillow comprising at least one layer comprising the RP Foam of claim 1.

18. A cushioning component for a container selected from the group consisting of packaging containers, display containers and combinations thereof where the cushioning component comprises the RP Foam of claim 1.

19. A flexible cellular latex foam with reflective particulates comprising a cross-linked latex foam and reflective particulates which have at least one reflective surface per particle that is of sufficient size to be visually distinguishable from the flexible latex foam without the use of magnification, and said reflective particulates are dispersed in the flexible cellular foam.

20. A flexible cellular melamine foam with reflective particulates comprising a cross-linked melamine foam and reflective particulates which have at least one reflective surface per particle that is of sufficient size to be visually distinguishable from the flexible melamine foam without the use of magnification, and said reflective particulates are dispersed in the flexible cellular foam.
